(19) United States
(12) Patent Application Publication
(10) Pub. No.: US 2019/0346004 A1
(43) Pub. Date: Nov. 14, 2019

(54) SHOCK ABSORBER

(71) Applicant: Scott Sports SA, Givisiez (CH)

(72) Inventors: Joe HIGGINS, Givisiez (CH); Pierre-Geoffroy PLANTET, Givisiez (CH)

(21) Appl. No.: 16/353,260

(22) Filed: Mar. 14, 2019

(30) Foreign Application Priority Data
May 14, 2018 (DE) 20 2018 102 676.3

(51) Int. Cl. F16F 9/02; B62K 25/08; B62K 25/28; F16F 9/32; B62K 3/00; G01B 11/14; G01S 17/10

(52) U.S. Cl. CPC F16F 9/0218; B62K 25/08; B62K 25/28; F16F 9/029; F16F 9/3264; F16F 9/3292; H04W 4/80; G01B 11/14; G01S 17/10; F16F 2228/066; F16F 2230/08; F16F 2230/0047; B62K 3/00

(57) ABSTRACT

A shock absorber assembly for cycling includes a shock absorber (2a, 2b) for connecting two subassemblies that are movable relative to each other, and a distance sensor (15) that is fixedly disposed in the interior of, or on, the shock absorber or on one of the two subassemblies. The distance sensor senses, detects or determines measurement values that represent a momentary spacing between the two subassemblies, which spacing varies during cycling. The distance sensor (15) may be a time-of-flight sensor that uses light in the ultraviolet, visible or infrared wavelength range. A bicycle (1), such as a mountain bike or a racing bike, may include such a shock absorber assembly mounted thereon.

### CROSS-REFERENCE TO RELATED APPLICATION

This application claims priority to German utility model application no. 20 2018 102 676.3 filed on May 14, 2018, the contents of which are fully incorporated herein by reference.

### TECHNICAL FIELD

The present invention generally relates to a shock absorber assembly, e.g., for cycling (e.g., bicycles), a shock absorber system for operating such a shock absorber assembly, and a bicycle having such a shock absorber assembly or such a shock absorber system.

### BACKGROUND

Nowadays bicycles typically include a front-wheel shock absorber and often also a rear-wheel shock absorber. In particular, bicycles for the off-road market, such as mountain bikes, often have a relatively long spring travel (i.e. the maximum spring compression or deflection from its unloaded state), in some cases more than 300 mm. In addition, some road bicycles, such as racing bikes, also include shock absorbers having a spring travel of, for example, 10 mm.

In some known embodiments, the shock absorbers have a plurality of adjustment options to adjust, e.g., spring stiffness (optionally variable, for example, progressive spring stiffness) and damping rate(s), which can be adjusted separately, for example, for the compression stroke and rebound stroke (extension or return to origin) and also for different road speeds or roadway characteristics. For this reason, a rapid determination of ideal shock absorber settings, in particular when the spring travel (spring deflection) is large and/or road speeds are high, is not trivial. As a result, there is a need in the art for assistance with the determination of appropriate shock absorber adjustments and/or an automatic adjustment of the shock absorber.

In addition, optimal shock absorber adjustments also depend on momentary roadway characteristics, which may change while cycling, so that there is also a need in the art for a rapid readjustment of the shock absorber while cycling.

In order to be able to give appropriate suggestions for optimal shock absorber adjustments to a user or, optionally, to be able to automatically adjust the shock absorber, it is important to know the exact operating state, in particular the compression or deflection state, of the shock absorber.

Various proposals have previously been made for this purpose. For example, it has been proposed to measure the pressure in an air-spring chamber of the shock absorber in order to determine the operating state. However, this is an indirect and consequently unreliable measurement, since the pressure in an air-spring chamber depends not only on the deflection (compression) state of the shock absorber, but also, for example, on the temperature of the shock absorber, which can deviate considerably from the ambient temperature. Moreover, fluid-dynamic effects can distort the pressure measurement.

Furthermore, it has also been proposed to provide magnetic or optical sensors on components of the bicycle frame that are movable relative to one another when the shock absorber deflects (compresses). However, the translational or rotational displacement of two components or subassemblies, which are movable with respect to each other on the bicycle, is often slight, which makes a satisfactory accuracy or resolution of the measurement difficult.

Moreover, additional components are also usually required on the bicycle frame, which is disadvantageous with respect to weight and costs. In addition, these components must be encapsulated or otherwise protected from contamination and damage.

### SUMMARY OF THE DISCLOSURE

It is therefore one non-limiting object of the present teachings to disclose a shock absorber assembly that makes possible a determination of the operating state or compression state of the shock absorber with high temporal resolution while minimizing structural complexity.

The present teachings are applicable to a wide variety of vehicles, such as (without limitation) all types of bicycles, including mountain bikes, racing bikes, hybrid bikes, trekking bicycles, pedelecs, recumbent bicycles, electric bicycles, etc., as well as all other two-wheelers or multi-wheel vehicles, on which such shock absorbers may be advantageously used.

A shock absorber assembly according to one aspect of the present teachings comprises a shock absorber that mechanically connects two subassemblies of a bicycle that are movable or moving relative to each other, as well as a distance sensor that is configured to determine measurement values that represent a relative spacing of the two subassemblies. Preferably, the distance sensor is fixedly disposed in the interior of the shock absorber or on the shock absorber, for example, outside and/or directly on the shock absorber, or on one of the two movable subassemblies. The measurement values thus provide at least one measure of the (momentary) distance between the two movable subassemblies while cycling and thus a measure of the operating state or compression state of the shock absorber.

Depending on the design and functionality of the distance sensor, it can, for example, directly determine the distance in length units (for example, millimeters) as the measurement values. Generally speaking, the distance sensor is preferably configured to determine a value such as a signal transit time, a signal strength, a phase shift, etc. as the measurement values, from which the relative spacing between the two subassemblies can be determined, substantially or completely without influence of other values and/or parameters.

Thus, the distance sensor preferably makes possible a direct and instantaneous determination of the relative spacing between the two subassemblies that the shock absorber connects at a high temporal resolution. This, in turn, makes possible an effective analysis of the operating-, deflection-, and/or compression state(s) assumed by the shock absorber over the course of time (e.g., while cycling).

For example, the distance sensor may carry out a differential determination of the spacing (i.e., a detection of spacing changes). However, the distance sensor preferably carries out an absolute determination of the relative spacing between the two subassemblies. It is therefore possible in principle to use distance sensors such as ultrasound- or radar-sensors that emit and detect, for example, electromagnetic waves or sound waves of suitable frequency, and instantaneously determine the spacing between the two movable sub-assemblies on the basis of the transit time or signal attenuation.

In one preferred design, the distance sensor is a so-called time-of-flight sensor (hereinafter “TOF sensor”), i.e. a transit-time sensor or light-transit-time sensor. Such a TOF sensor preferably comprises a light-transmitting and -receiving unit that is fixedly connected to one of the two subassemblies, and measures, directly, or, for example, via a phase shift, the transit time of a light signal transmitted and reflected by an object (usually an element of the other of the two movable subassemblies). Preferably, the TOF sensor uses light in the ultraviolet, visible, and/or infrared spectral range. As the light signal, the TOF sensor may use light pulses emitted at a high frequency (for example, between 0.01 and 1000 kHz). The use of such a time-of-flight sensor therefore makes possible a continuous or quasi-continuous determination of the (momentary) spacing between the two components (or subassemblies) of the shock absorber, which components move relative to each other when the shock absorber deflects (compresses).

When the shock absorber is installed and/or used, the two subassemblies (components) may simply move relative to each other according to an exclusively translatory, linear movement along a (straight) axis that coincides (or is parallel) with a longitudinal axis of the shock absorber. This type of arrangement ensures a simple determination of the relative spacing between the two subassemblies that are movable or displaceable relative to each other, because the components within each subassembly are typically each fixedly connected to one another, so that no relative positional change takes place between the components of one subassembly. However, if the subassemblies undergo, for example, rotational or another type of relative movements, e.g., non-linear movement(s), relative to each other, such non-linear movement(s) may be converted, for example, by a rocker link (rocker arm, bellcrank) into a purely translatory (linear) movement in the shock absorber itself. Accordingly, an exclusively translatory, linear movement thus takes place in the shock absorber in such embodiments.

In one preferred embodiment, the distance sensor is disposed in the interior of the shock absorber. The shock absorber preferably includes a cylinder and a reciprocating piston or a piston that is otherwise movable or displaceable in the cylinder. In such an embodiment, the cylinder axis or the common axis of symmetry of the cylinder and piston forms the longitudinal axis of the shock absorber, along which the piston is movable in the cylinder, and in the simplest case the two subassemblies are also movable relative to each other. The cylinder and piston then respectively form a structural element of the two different movable subassemblies. The piston and cylinder enclose a volume that forms and defines the so-called air-spring chamber. The air-spring chamber is filled with a gas (e.g., nitrogen), with a gas mixture, and/or with air, wherein the amount of gas and/or air in the air-spring chamber typically remains constant during operation and is changed only, for example, to adjust the spring stiffness of the shock absorber. However, the volume occupied by the air-spring chamber is variable and is changed with deflection (compression) and rebound (extension) of the shock absorber. Shock absorbers according to the teachings preferably exclusively use the air-spring chamber as the sole spring element for dampening shocks, vibration, etc., during cycling. If other types of spring elements such as elastomers, steel springs, etc. are omitted, the structural complexity and the part count are reduced, thereby leading to a cost- and weight-reduction.

The distance sensor is preferably arranged or disposed within the air-spring chamber volume. In such a preferred embodiment, at least the light-transmitting- and -receiving-unit of the distance sensor, in the simplest case the entire distance sensor, is completely disposed in the interior of the air-spring chamber. In this case, the distance sensor is effectively protected from damage and contamination by being enclosed in the sealed (e.g., light- and air- or gas-tight) air-spring chamber. In addition, the functioning of the distance sensor or of the light-transit-time sensor is improved, since the air-spring chamber is light-protected (shielded from ambient light) and also forms a space substantially protected from environmental influences. Furthermore, no additional installation space is required for the shock absorber owing to the arrangement of the distance sensor within the air-spring chamber or in the interior of the shock absorber.

Preferably, the distance sensor or the light-transit-time-sensor or TOF-sensor is preferably disposed along the longitudinal axis of the shock absorber and/or it is configured to emit light in the direction of or along or essentially in the direction of the longitudinal axis and to receive light from this direction. In such embodiments, the signal or light emitted by the distance sensor or light-transit-time-sensor or TOF-sensor exclusively propagates in the air-spring chamber or in the interior of the shock absorber. For this purpose, the distance sensor or light-transit-time sensor is, for example, fixedly attached to the cylinder, for example, on a base of the cylinder, which base faces the air-spring chamber, and transmits measurement- or light-signals that emanate from the cylinder base toward the piston. In this case, the side of the piston that opposes the distance sensor, i.e. the side of the piston facing the air-spring chamber, is preferably lightly colored (for example, white) and/or is designed in reflective manner for reflecting the measurement- or light-signals back toward the light sensor. Alternatively, the distance sensor can also be disposed in the above-described orientation spaced apart from the cylinder base.

The distance sensor is preferably disposed at a position that is spaced between 0.1 and 50 mm from the position of the piston or its side (piston underside) facing the air spring at maximum compression of the shock absorber or of the air-spring chamber, i.e. in the maximally deflected (compressed) state of the shock absorber. This minimum distance is then, for example, 0.1, 0.2, 0.5, 1, 2, 5, 10, 20 or 50 mm, wherein each of the mentioned values can also be an upper or lower limit of a range defined thereby.

Alternatively, the distance sensor may be disposed on the side of the piston facing the air-spring chamber, and the signal or light is emitted along the longitudinal axis of the cylinder toward the cylinder base opposite the piston. In this case, the cylinder base is preferably lightly colored (for example, white) and/or designed in a reflective manner for reflecting the measurement- or light-signals.

The shock absorber or the shock absorber assembly can be a rear-wheel shock absorber or a front-wheel shock absorber. In the case of a front-wheel shock absorber, the shock absorber or the shock absorber assembly is disposed in a front-wheel fork, which then forms a suspension fork. Depending on the design, the suspension fork can comprise one or two shock absorbers, for example, in two fork tubes (telescoping tubes or legs of the front fork) that hold the front wheel. if the front suspension fork has two shock absorbers, the distance sensor is preferably disposed in the interior of only one of the shock absorbers of the suspension fork in order to minimize costs and/or complexity, although of course distance sensors may be placed in both shock absorbers of the front suspension fork.

In an alternative embodiment, the distance sensor is fixedly disposed on the shock absorber, for example, outside (externally) and/or directly on the shock absorber, or on one of the two movable subassemblies.

As was explained above, if the shock absorber(s) is (are) disposed in a front-wheel fork, a front suspension fork is provided. In such an embodiment, the first subassembly preferably comprises, for example, the fork steerer tube of the suspension fork and/or the head tube of the bicycle frame, while the second subassembly comprises the lower part of the suspension fork or the fork tubes (legs), the front wheel held by the fork tubes, and optionally a mudguard. Depending on the design, a fork crown or a fork bridge is preferably also provided in either of the first, upper subassembly or the second, lower subassembly.

In such embodiments, the distance sensor is preferably fixedly disposed on the first subassembly, for example, in or on the head tube or in or on the fork steerer tube. The distance sensor then emits light toward the second subassembly, for example, toward the front wheel and/or mudguard, preferably on or along or parallel to a fork-steerer-tube axis or parallel to a longitudinal axis of the shock absorber, and detects light reflected by the second subassembly, for example, by the fork crown or the mudguard. Alternatively, the distance sensor can also be disposed on the second subassembly and be configured to emit light toward the first subassembly and to detect light reflected therefrom.

Alternatively the shock absorber forms a rear-wheel shock absorber, and the distance sensor is disposed outwardly or externally and/or directly on a section of the shock absorber, which section is fixedly connected to a first movable subassembly or associated with the first subassembly. The distance sensor is preferably configured to emit, during operation, light along, or essentially along, a longitudinal axis of the shock absorber and/or light toward a second movable subassembly, e.g., toward a rocker link of the rear-wheel suspension, and to detect light reflected therefrom. In such an embodiment, the first subassembly comprises, for example, a bottom bracket, a down tube, a seat tube, and/or a top tube of the bicycle frame, while the second subassembly comprises a seat stay.

The shock absorber is preferably designed to permit a maximum spring travel (maximum deflection or compression) of at least or at most 10 mm, 20 mm, 50 mm, 100 mm, 150 mm, 200 mm, and/or 300 mm. Each of the values mentioned can also represent upper or lower range limits of the spring travel.

As already mentioned, the distance sensor or the light-transit-time sensor is configured to determine measurement values that represent a relative spacing between the subassemblies that are movable relative to each other along the longitudinal axis of the shock absorber. In some embodiments of the present teachings, the distance sensor is preferably further configured to determine the measurement values continuously or quasi-continuously or at predetermined points of time, for example, periodically. For example, the distance sensor may periodically determine the distance or corresponding measurement values at a frequency (sampling rate) of between 0.01 and 1,000 kHz, for example, at a frequency (sampling rate) of 0.01, 0.02, 0.05, 0.1, 0.2, 0.5, 1.0, 2.0, 5.0, 10, 20, 50, 100, 200, 500 or 1,000 kHz, wherein each of the mentioned values can also be an upper or lower limit of the range mentioned.

A shock absorber assembly according to the present teachings preferably comprises a shock absorber according to any of the above-described or below-described embodiments and a control unit for the controlling and reading-out of the distance sensor (or the light-time-transit sensor). In the simplest case the control unit (for example, an integrated logic circuit) is structurally part of the distance sensor or disposed directly on the distance sensor and is disposed, for example, on a common circuit board with the distance sensor. For example, the control unit may control the signal- or light-transmitting- and -receiving-unit of the distance sensor and read-out the measurement values captured by the receiving unit.

Such a shock absorber assembly preferably further or alternately comprises one or more operating means that provide one or more further functionalities such as measurement-value-processing and measurement-value-analysis, display of information, data storage, shock absorber adjustment, controlling and reading of sensors, such as of the distance sensor, etc. In a preferred design, such operating means is/are structurally integrated in the shock absorber or disposed directly on the shock absorber. Likewise, one or more further sensors can also be structurally integrated in the shock absorber or disposed directly on the shock absorber, such as, for example, one or more of a speed sensor, a position sensor, an acceleration sensor, and/or a gyroscopic sensor.

Alternatively, the shock absorber assembly can also be part of a shock absorber system that provides such further functionalities with the aid of one or more operating units that is (are) structurally separate from the shock absorber assembly, which operating units comprise the mentioned operating means. In such an embodiment, a part of the operating means can also be provided on/in the shock absorber or the distance sensor, and a part of the operating means can also be provided in one or more operating units that is/are structurally separate from the shock absorber assembly. Data/signal communication between the shock absorber assembly (or its distance sensor and/or its control unit) and a specific operating means/operating unit can be provided in a wired (cabled) manner and/or wirelessly. The wireless communication may be effected, for example, using Bluetooth®, ANT+®, Wi-Fi, WLAN, NFC, or another radio standard. For wired or cabled communication, known transmission standards are preferably also used.

In such embodiments, two or more shock absorbers or shock absorber assemblies, preferably front-wheel and rear-wheel shock absorber assemblies, can also be monitored, read-out, and optionally controlled within the shock absorber system. It is also possible to distribute the various operating means or functionalities over two or more operating units, for example, a display unit (operating unit having a display means), that is provided, for example, for attachment to the handlebars, and an operating unit different therefrom for processing the data.

The operating unit or one of the operating units is preferably configured as a portable computer (mobile device), such as as a smartphone, a tablet, a wearable device (such as a smartwatch, wrist-mounted computer, or eyeglasses with an optical head-mounted display), etc., each having software stored therein with instructions for performing any of the functions disclosed herein, for example, a so-called app or another type of computer program.

In addition or in the alternative, shock absorber assemblies according to the present teachings preferably comprise a transmitting unit and/or receiving unit for cabled (wired) or wireless communication of data between the distance sensor and/or the shock absorber assembly or its control unit and one or more external operating units. The data is, for example, measurement values of the distance sensor or optionally processed measurement values, such as the (momentary) spacing between the piston and the cylinder or the spacing between the two subassemblies. The communication of the data may take space continuously or at predetermined times, preferably periodically, for example, at the same frequency with which the distance sensor also determines the measurement values, or at a lower frequency, which saves energy and correspondingly prolongs the operating time of an energy supply unit of the shock absorber assembly.

Accordingly, the communication of the data may take place, for example, at a frequency between 0.01 Hz and 1000 kHz, for example, at 0.01 Hz, 0.02 Hz, 0.05 Hz, 0.1 Hz, 0.2 Hz, 0.5 Hz, 1.0 Hz, 2.0 Hz, 5.0 Hz, 10 Hz (0.01 kHz), 0.02 kHz, 0.05 kHz, 0.1 kHz, 0.2 kHz, 0.5 kHz, 1.0 kHz, 2.0 kHz, 5.0 kHz, 10 kHz, 20 kHz, 50 kHz, 100 kHz, 200 kHz, or 1000 kHz, wherein each of the mentioned values can also be an upper or lower limit of a range defined thereby. A preprocessing of the measurement values is preferably performed in the shock absorber assembly or in a processing means (processor or CPU) of the shock absorber assembly.

In addition or in the alternative, shock absorber assemblies according to the present teachings preferably further comprise one or more adjusting units for adjusting one or more operating parameters or operating characteristics of the shock absorber. Preferably the adjusting unit(s) is/are driven mechanically (by a user) or by an electric motor. In such embodiments, the adjustable operating-parameters or operating-characteristics may be, for example, the spring stiffness or the damping rate(s) during deflection (compression) and/or rebound (extension), which are optionally adjustable in a speed-dependent manner, so that, for example, different damping rates result at low and high riding speeds.

In addition or in the alternative, shock absorber assemblies according to the present teachings or shock absorber systems according to the teachings preferably further comprise one or more processing means (one or more processors configured/programmed) for processing the measurement values determined by the distance sensor. For example, if the measurement value only represents a measure of the spacing between the two movable subassemblies, then the actual relative spacing in length units or, for example, a displaced position of the piston in the cylinder is determined. Furthermore, the measurement values or the determined distances can be analyzed, and adjustment information for the adjusting of the operating parameters of the shock absorber(s) can be generated using the adjusting unit(s) and used and/or displayed.

In addition or in the alternative, shock absorber assemblies according to the teachings or shock absorber systems according to the teachings further preferably comprise one or more display means (e.g., a display or screen, such as an LCD or LED screen, e.g., a touch screen) for the display of information, preferably with regard to the operating state and/or adjustments made or to be made to the adjusting unit(s) of the shock absorber or the shock absorber assembly. Such display information is generated, for example, by the processing means (processor) and communicated to the display means and displayed to the user or the cyclist.

If, for example, manually operated mechanical adjusting units are provided on the shock absorber(s), corresponding adjustments to the shock absorber can be made with the aid of a tool and/or by hand, optionally even during cycling. On the other hand, if the adjusting units are driven by an electric motor, adjustment information determined by the processing means (processor) may be transmitted instantaneously to the adjusting unit(s), and the corresponding adjustments are made automatically, i.e. without further assistance from the user. In this case, any adjustments that are automatically made may be communicated to the display means and displayed thereon.

In addition or in the alternative, shock absorber assemblies according to the teachings or shock absorber systems according to the teachings preferably further comprise a storage means (e.g., computer memory, such as RAM, flash memory, etc.) for the storing of data such as measurement values, processed measurement values, spacings between the components, operating information, adjustment information, display information, etc. Accordingly, it is possible, for example, to log the measurement values or the spacing between the two movable components and thus the compression state of the shock absorber, and to read it out in a collected state at a later time, for example, after the end of a ride.

In addition or in the alternative, shock absorber systems according to the teachings and/or shock absorber assemblies according to the teachings preferably further comprise at least one further sensor in addition to the distance sensor, such as a speed-, position-, acceleration- and/or gyroscopic sensor, that is disposed, for example, directly on the shock absorber or at another location on the bicycle. In such an embodiment, the processing means (processor) may be provided in the shock absorber or in the shock absorber assembly or in the shock absorber system and may be preferably further configured to capture measurement values of the at least one further sensor and to take into account the measurement values or distances captured by the distance sensor in the display and/or in the processing and/or in the determination of the adjustment information. For example, different riding speeds can thus be distinguished, or “difficult” and “easy” terrain can also be distinguished between. If no external operating unit is present, it is preferred to control the at least one further sensor with the aid of a processing means provided in the shock absorber assembly itself. The shock absorber system is then comprised only of the shock absorber assembly according to any one of the above-described or below described embodiments of the present teachings and the further sensor(s).

A bicycle according to the present teachings comprises any one of the shock absorber assemblies as described above or below or any one of the shock absorber systems as described above or below. The bicycle is preferably configured as a mountain bike, such as a full-suspension mountain bike, or as a racing bike.

### BRIEF DESCRIPTION OF THE DRAWINGS

Further objects, embodiments and advantages of the present teachings are described below with reference to the exemplary embodiments shown in the accompanying Figures. The exemplary embodiments represent preferred embodiments that do not restrict the teachings in any way. The appended Figures are schematic representations that do not necessarily reflect the actual proportions but provide improved clarity and understanding of the exemplary embodiments.

FIG. 1 shows a side view of a bicycle.

FIG. 2A shows a cross-section through a shock absorber assembly according to a first exemplary embodiment.

FIG. 2B shows a cross-section through a shock absorber assembly according to a second exemplary embodiment.

FIG. 3 shows a shock absorber system.

FIG. 4 shows a third exemplary embodiment of a shock absorber assembly.

FIG. 5 shows a fourth exemplary embodiment of a shock absorber assembly.

FIG. 6 shows a fifth exemplary embodiment of a shock absorber assembly.

### DETAILED DESCRIPTION OF EXEMPLARY EMBODIMENTS

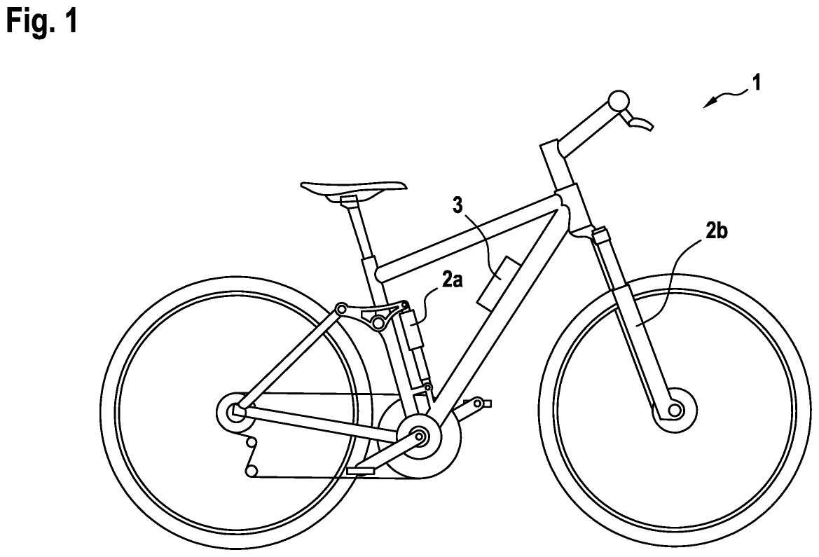

FIG. 1 shows a bicycle 1 in the form of a full-suspension mountain bike including a rear-wheel shock absorber 2a and a front-wheel shock absorber 2b mounted in a suspension fork.

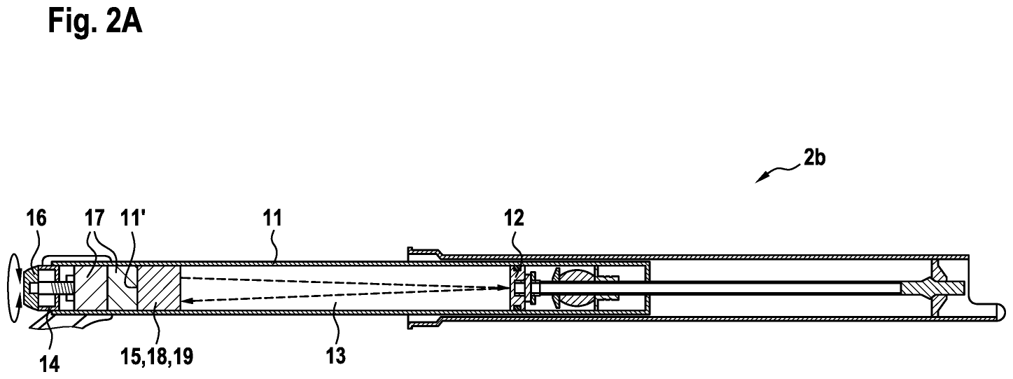

A cross-section through the front-wheel shock absorber 2b installed in the suspension fork according to a first exemplary embodiment of a shock absorber assembly is depicted in FIG. 2A. The construction principle is identical for a rear-wheel shock absorber 2a. The shock absorber 2b is air sprung and comprises a cylinder 11 and a piston 12 that enclose an air-spring chamber 13, which is filled with air in the present exemplary embodiment. The cylinder 11 is fixedly connected to the fork crown 14, forms the upper section of the suspension fork, and itself submerges into (is slidably disposed within) a telescoping tube (lower leg) that forms one side of the lower section of the suspension fork. It is noted that another cylinder and piston, e.g., without the distance sensor according to the present embodiment, may be provided in a second, parallel telescoping tube (lower leg) that is disposed on the opposite side of the front wheel and thereby forms the other side of the lower section of the suspension fork.

In the present embodiment, the cylinder 11 is fixedly connected to a fork steerer tube and also fixedly connected—with respect to the longitudinal direction of the shock absorber 2b—to a head tube of the bicycle frame (that is, as viewed from the rotational movement of the fork steerer tube in the head tube). Thus, in this exemplary embodiment, the fork crown, the fork steerer tube, and the head tube are parts of the first subassembly.

The piston 12 is fixedly connected via a piston rod to the lower section of the suspension fork, to which the front wheel is also attached. The lower section of the suspension fork and the front wheel are thus parts of the second subassembly.

When the upper section of the suspension fork submerges into and rebounds out of the lower section of the suspension fork during cycling, the piston 12 moves relative to the cylinder 11 along the longitudinal axis of the shock absorber. In the present embodiment, this longitudinal axis is also (coincides with) the axis of symmetry of the shock absorber and the piston rod is also located on this longitudinal axis. When the upper section of the suspension fork submerges into the lower section of the suspension fork, the relative distance between the piston 12 and the cylinder 11 (or the cylinder base 11′) is reduced and the air-spring chamber 13 is compressed, so that a counterforce is generated for the rebounding (i.e. the subsequent extension back to the point of origin of the shock absorber).

In the air-spring chamber 13, a distance sensor 15 in the form of a time-of-flight sensor (TOF sensor) is disposed on the cylinder base 11′, which may be formed by one or more spacers 17 (two spacers 17 in the present exemplary embodiment). As indicated by the dashed arrow in FIG. 2A, the TOF sensor 15 emits light pulses toward the piston 12, receives the light reflected by the opposing side of the piston 12, and determines the transit time of the light pulse. From these measurement values (transit time), the (momentary) relative distance between the TOF sensor 15 or the cylinder 11 and the piston 12 and thus the operating or compression state of the shock absorber 2b can then be deduced in an instantaneous and direct manner.

In the present embodiment, the shock absorber 2b comprises a mechanism for adjusting the spring stiffness and this mechanism comprises a rotary knob 16 and one or more spacers 17. With the aid of the rotary knob 16, a user can move the spacer(s) 17 along the longitudinal axis of the cylinder 11 and thus reduce or increase the volume of the air-spring chamber 13. The spring stiffness is thereby respectively increased or reduced. The shock absorber 2b further comprises damping elements, which are not depicted in more detail but are generally also adjustable, whereby the damping rate or the various damping rates can be adjusted.

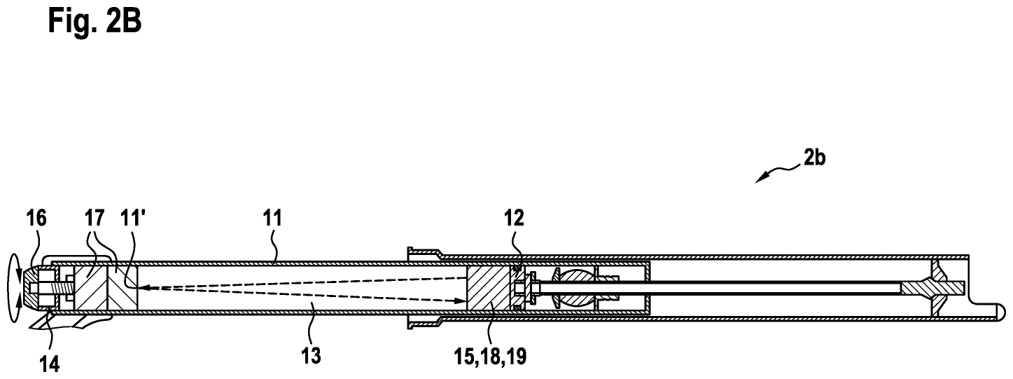

In the present exemplary embodiment, the TOF sensor 15 is an integrated TOF sensor 15; that is, it forms a structural unit with an associated control unit 18 for controlling and reading-out the TOF sensor 15, and with a transmission unit 19 for wireless transmission of the measurement values to an external operating unit 31 (see FIG. 3). Furthermore, an energy supply (not shown) in the form of a battery or rechargeable battery is integrated in the physical unit of the TOF sensor 15. Alternatively, the power supply can also be effected in a wired manner, for example, via the fork crown 14. In the case of a rechargeable battery, such a wired connection can also be used for charging the rechargeable battery. As a further alternative, contactless (wireless, inductive) charging of the rechargeable battery integrated in the subassembly of the TOF sensor 15 can also be provided.

In a second exemplary embodiment of the present teachings shown in FIG. 2B, the distance sensor 15 is disposed on the side of the piston 12 and faces towards the air-spring chamber 13. The signal or light from the distance sensor 15 is emitted along the longitudinal axis of the cylinder 11 toward the cylinder base 11′ that is disposed opposite the piston 12. In this embodiment, the cylinder base 11′ is preferably lightly colored (for example, white) and/or designed in a reflective manner for reflecting the measurement- or light-signals back towards the sensor 15.

In the second exemplary embodiment as well, the distance sensor 15 may be an integrated TOF sensor 15 and it may be disposed in an integral structural unit with an associated control unit 18 for controlling and reading-out the TOF sensor 15, and with a transmission unit 19 for wireless transmission of the measurement values to an external operating unit 31 (see FIG. 3). Similar to the first exemplary embodiment, an energy supply (not shown) in the form of a battery or rechargeable battery may be integrated in the physical unit of the TOF sensor 15. Alternatively, the power supply can also be effected in a wired manner, for example, via the fork crown 14. If the energy source is a rechargeable battery, such a wired connection can also be used for charging the rechargeable battery. As a further alternative, contactless (wireless, inductive) charging of the rechargeable battery integrated in the subassembly of the TOF sensor 15 can also be provided.

A shock absorber system 30 is depicted in FIG. 3 and comprises the shock absorber assembly depicted in FIG. 2A having the front-wheel shock absorber 2b, although the shock absorber assembly depicted in FIG. 2B also may be utilized in this shock absorber system 30. The shock absorber system 30 further comprises the integrated TOF sensor 15 (with the control unit 18 and transmission unit 19). Accordingly, a communication connection to an external operating unit 31 can be produced. Because the operating unit 31 includes a receiving means (receiver) 32 corresponding to the transmission unit 19, it can thus read out and process measurement values determined (sensed, detected) by the TOF sensor 15. In the depicted exemplary embodiment, the operating unit 31 further comprises a display means (e.g., an LCD screen, such as a touchscreen) 33 for displaying information to a user/cyclist. The operating unit 31 is, for example, a portable computer (mobile computer or mobile device), such as a smartphone, a wearable device (e.g., a smartwatch, a head-mounted optical display, etc.) or the like. The operating unit 31 further comprises software 34 that includes instructions for processing the measurement values received from the shock absorber 2b and for depicting the results of processing these measurement values and/or operating and/or adjustment information on the display means 33. Using the depicted adjustment information, the user can make manual adjustments to the shock absorber 2b, for example, using the rotary knob 16; in the present case, for example, the spring stiffness can be changed.

In the present exemplary embodiment, the shock absorber system depicted in FIG. 3 also comprises a rear-wheel shock absorber 2a or a rear-wheel shock absorber assembly, which also comprises a TOF sensor 15′, a transmission unit 19′, and an adjusting unit 16′, whose functions and construction are analogous to the above-described front-wheel shock absorber 2b. Accordingly the operating unit 31 can also communicate with the rear-wheel shock absorber assembly 2a and output corresponding information about the rear-wheel shock absorber 2a on the display means 33.

In the example shown in FIG. 3, the shock absorber system 30 also comprises a further acceleration sensor 3 that is disposed on the frame of the bicycle 1. This acceleration sensor 3 measures the acceleration exerted on the frame of the bicycle while cycling and also communicates with the operating unit 31, which then also uses the data of the acceleration sensor 3 when generating the display information, such as the operating and/or adjustment information. Alternatively or additionally, a speed sensor and/or a position sensor can be provided. Furthermore, in addition or in the alternative, one or more other sensors, such as an acceleration sensor, a speed sensor, and/or a position sensor, may be provided in or on the shock absorber, i.e. as a structural unit with the shock absorber, optionally in the interior of the shock absorber.

Optionally, one or both of the assemblies comprising the front and/or rear shock absorbers 2a, 2b may further comprise a display means (e.g., an LCD screen, such as a touchscreen) 33 for displaying information to a user/cyclist. In such embodiments, one or both of the assemblies comprising the front and/or rear shock absorbers 2a, 2b further comprises software 34 that includes instructions for processing the measurement values received from the shock absorber 2a, 2b and for depicting the results of processing these measurement values and/or operating and/or adjustment information on the display means 33.

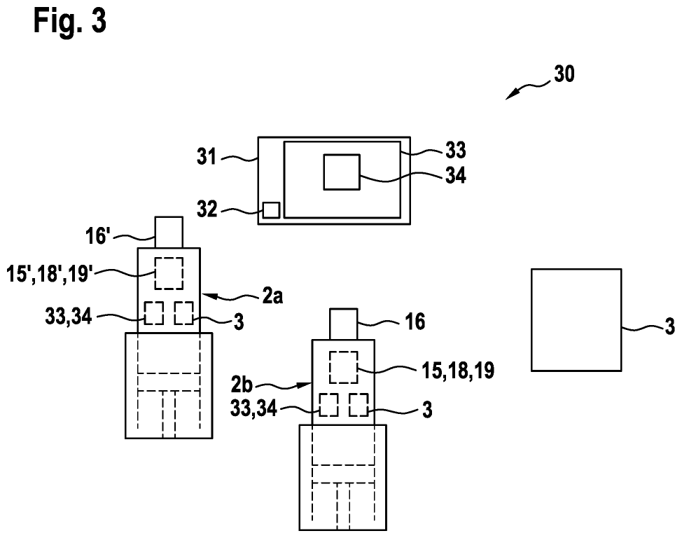

A third exemplary embodiment of the present teachings is depicted in FIG. 4, wherein the (integrated) TOF sensor 15 is disposed externally on the front-wheel shock absorber 2b. In this embodiment, the TOF sensor 15 is fixedly disposed on or in the first subassembly, which in the present case comprises the head tube 40 of the bicycle frame, the fork steerer tube 41 of the suspension fork, and the fork crown 14. More precisely, in the depicted exemplary embodiment, the TOF sensor 15 is disposed in the interior of the fork steerer tube 41 and emits light signals parallel to the longitudinal axis of the suspension fork or of the front-wheel shock absorber 2b toward a mudguard 42 that is a part of the second subassembly, which further comprises the lower section of the suspension fork (e.g., the telescoping tubes/lower legs) and the front wheel. In the present exemplary embodiment an opening (not shown) on the lower side of the fork steerer tube 41 is provided for the exit of the light signals of the TOF sensor 15 from the interior of the fork steerer tube 41 and for the entry of the light signals reflected by the mudguard 42.

By determining the relative distance between the TOF sensor disposed in the fork steerer tube 41 and the mudguard 42, the compression state of the front-wheel shock absorber 2b can in turn be instantaneously deduced. Alternatively, it is also possible to reflect the light signals of the TOF sensor 15 to another component of the second subassembly, such as, for example, a stabilizer of the lower section of the suspension fork, which, for example, fixedly connects the two telescoping tubes (lower legs).

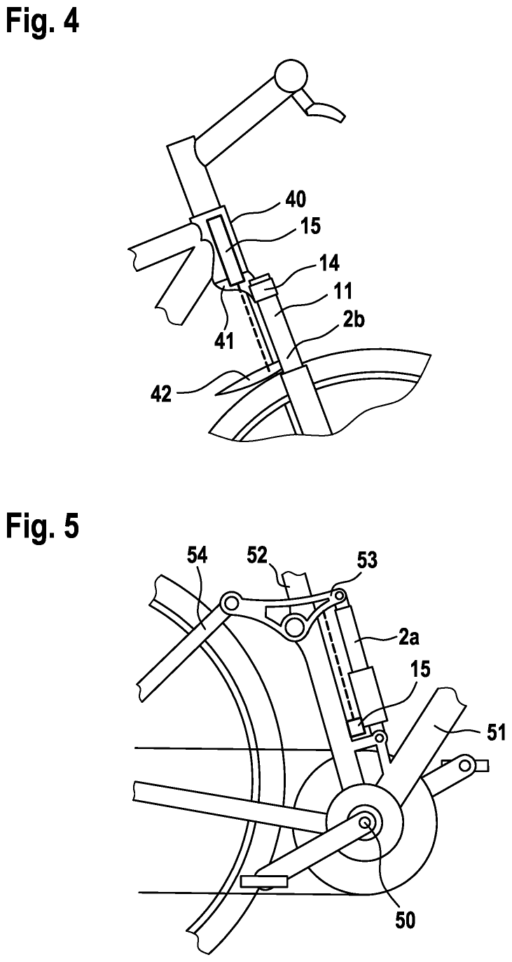

A fourth exemplary embodiment of the present teachings is depicted in FIG. 5. In this embodiment, one side (end) of a rear-wheel shock absorber 2a is rotatably attached in a known manner in the vicinity of the bottom bracket 50 at the transition between the down tube 51 and the seat tube 52. The other side (end) of the rear-wheel shock absorber 2a is rotatably attached to the seat stay 54 via a rocker link (bellcrank) 53. The TOF sensor 15 is disposed externally and directly on the rear-wheel shock absorber 2a at a location of the rear-wheel shock absorber 2a that is part of a first subassembly, which in this exemplary embodiment comprises the bottom bracket 50, the down tube 51, and the seat tube 52, or is associated with this first subassembly.

The TOF sensor 15 emits light signals parallel or essentially parallel to the longitudinal axis of the rear-wheel shock absorber 2a toward the rocker link 53 (second subassembly) and receives reflected light signals from there, whereby the distance between the rocker link 53 and the part of the rear-wheel shock absorber 2a associated with the first subassembly can be directly detected. In this embodiment, this distance changes in a manner approximately identical to the spacing of the piston 12 and the cylinder 11 (or the cylinder base 11′) in the front shock absorber 2a, whereby the compression state of the rear-wheel shock absorber 2a can be directly deduced. Alternatively, the deviation resulting from the rotational movement of the rocker link 53 can also be removed, for example, using a known lookup table that sets the spacing of TOF sensor 15 and rocker link 53 in relation to the actual compression state or the distance between the piston 12 and the cylinder 11 (or the cylinder base 11′) of the rear-wheel shock absorber 2a.

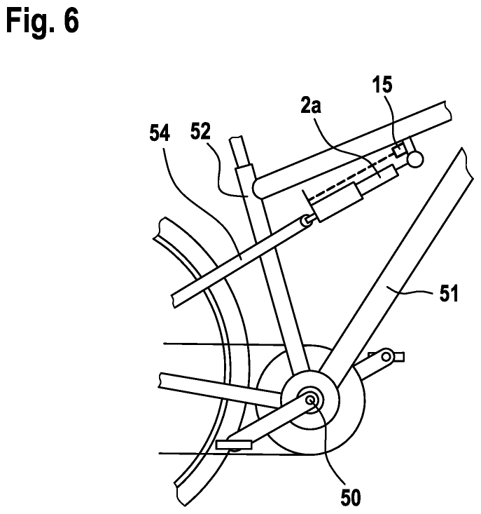

In a fifth exemplary embodiment of the present teachings depicted in FIG. 6, one side (end) of the rear-wheel shock absorber 2a is attached, likewise in a known manner, to the underside of a top tube of the bicycle frame, and the other side is attached to the seat stay. The TOF sensor 15 is in turn disposed at a location of the rear-wheel shock absorber 2a that is associated with a first subassembly that comprises the top tube in this exemplary embodiment. Accordingly, the TOF sensor 15 emits light signals parallel or essentially parallel to the longitudinal axis of the rear-wheel shock absorber 2a toward the seat stay (second subassembly) and receives light signals from there. The mountings may be rotatable on both sides of the rear-wheel shock absorber 2a; however, the rotational movement at these mountings is smaller during deflection than in the third exemplary embodiment depicted in FIG. 5. As a result, the deviation between the distance determined by the TOF sensor 15 and the actual compression state of the rear-wheel shock absorber 2a is smaller and usually negligible, so that, for example, a recalculation using a lookup table (as described in connection with the third exemplary embodiment) can be omitted.

Additional representative, non-limiting exemplary embodiments of the present teachings are described in the following.

1. Shock absorber assembly comprising:

a shock absorber (2a, 2b) that connects two subassemblies that are movable relative to each other, and

a distance sensor (15) that is fixedly disposed in the interior of, or on, the shock absorber or on a first of the two movable subassemblies, and that is configured to determine measurement values that represent a spacing between the two subassemblies.

2. Shock absorber assembly according to the preceding embodiment 1, wherein the distance sensor (15) is a time-of-flight sensor that preferably uses light in the ultraviolet, in the visible, or in the infrared wavelength range.

3. Shock absorber assembly according to the preceding embodiment 1 or 2, wherein the subassemblies are displaceable relative to each other along a longitudinal axis.

4. Shock absorber assembly according to any one of the preceding embodiments 1 to 3, wherein the distance sensor (15) is disposed in the interior of the shock absorber (2a, 2b), and a cylinder (11) of the shock absorber (2a, 2b) and a piston (12) of the shock absorber (2a, 2b) are respectively fixedly connected to any one of the two movable subassemblies.

5. Shock absorber assembly according to the preceding embodiment 4, wherein the cylinder (11) and the piston (12) define an air-spring chamber (13) that is preferably filled with a gas, with a gas mixture, and/or with air, and/or in which the distance sensor (15) is disposed.

6. Shock absorber according to the preceding embodiment 5, wherein the shock absorber exclusively uses the air-spring chamber (13) as a spring element.

7. Shock absorber assembly according to the preceding embodiment 4, 5, or 6, wherein the distance sensor (15) is disposed on the longitudinal axis and/or is oriented to emit light along, or essentially along, the longitudinal axis.

8. Shock absorber assembly according to any one of the preceding embodiments 4 to 7, wherein the distance sensor (15) is disposed on a cylinder base (11′), and an opposing side of the piston is preferably configured in a light and/or reflective manner.

9. Shock absorber assembly according to any one of the preceding embodiments 4 to 8, wherein, at a maximum compression of the shock absorber, the distance sensor (15) is disposed at a distance of 0.1 to 50 mm from the piston (12).

10. Shock absorber assembly according to any one of the preceding embodiments 4 to 9, wherein the distance sensor (15) is disposed on a side of the piston (12) facing the air-spring chamber (13), and a cylinder base (11′) is preferably designed in a lightly colored and/or reflective manner.

11. Shock absorber assembly according to any one of the preceding embodiments, wherein the shock absorber is a rear-wheel shock absorber (2a) or a front-wheel shock absorber (2b).

12. Shock absorber assembly according to any one of the preceding embodiments 1 to 3, wherein the shock absorber is a front-wheel shock absorber (2b), the first of the two movable subassemblies comprises a head tube of a bicycle frame and/or a fork steerer tube of a front-wheel fork, the second of the two movable subassemblies comprises a front wheel and/or a mudguard, and the distance sensor (15) is fixedly disposed on the first subassembly and preferably emits light toward the second subassembly, preferably along or parallel to a fork-steerer-tube axis.

13. Shock absorber assembly according to any one of the preceding embodiments 1 to 3, wherein the shock absorber is a rear-wheel shock absorber (2a), wherein the distance sensor is disposed fixedly, preferably externally, on a section of the shock absorber fixedly connected to the first movable subassembly, which section comprises the bottom bracket, and preferably emits light along, or essentially along, a longitudinal axis of the shock absorber and/or emits light toward the second movable subassembly, in particular of a rocker link (bellcrank) of the rear-wheel suspension.

14. Shock absorber assembly according to any one of the preceding embodiments, wherein a spring travel of the shock absorber is at least or at most 10 mm, 20 mm, 50 mm, 100 mm, 150 mm, 200 mm, and/or 300 mm.

15. Shock absorber assembly according to any one of the preceding embodiments, wherein the distance sensor (15) is configured to determine the measurement values continuously or at predetermined points of time, preferably periodically.

16. Shock absorber assembly according to the preceding embodiment 15, wherein the distance sensor (15) is configured to determine the measurement values periodically and/or at a frequency in the range between from 0.01 to 1000 kHz.

17. Shock absorber assembly according to any one of the preceding embodiments, further comprising a control unit (18) for controlling and/or reading-out the distance sensor (15).

18. Shock absorber assembly according to any one of the preceding embodiments, further comprising a transmission- and/or receiving unit (19) for wired or wireless transmission of data between the shock absorber and one or more external operating units (31), preferably at a frequency between 0.01 Hz and 1000 kHz.

19. Shock absorber assembly according to any one of the preceding embodiments, further comprising one or more adjusting units (16) for adjusting one or more operating parameters of the shock absorber, in particular spring stiffness and/or damping rate during deflection and/or rebound, which adjusting units (16) are preferably speed-dependent, wherein the adjusting unit(s) are preferably driven mechanically or by electric motor.

20. Shock absorber assembly according to any one of the preceding embodiments, further comprising a processing means for processing the measurement values, in particular for determining the spacing between the movable components (11, 12).

21. Shock absorber assembly according to any one of the preceding embodiments, further comprising a display means for the display of information, preferably of operating-state information and/or adjustment information of the shock absorber.

22. Shock absorber assembly according to any one of the preceding embodiments, further comprising a storage means for the storing of data, such as measurement values, processed measurement values, operating information, adjustment information, and/or display information.

23. Shock absorber assembly according to any one of the preceding embodiments, further comprising at least one further sensor (3), in particular a speed-, position-, acceleration-, and/or gyroscopic sensor, wherein the processing means (34) is preferably further configured to take into account measurement values of the further sensor in the display and/or the processing of the measurement values and/or in the determination of display- and/or adjustment-information, wherein the further sensor is preferably structurally integrated in or with the distance sensor.

24. Shock absorber system (30) comprising

at least one shock absorber assembly according to any one of the preceding embodiments, and

at least one operating unit (31) comprising a receiving- and/or transmitting means (32) for the communication of data between the shock absorber and the operating unit.

25. Shock absorber system (30) according to the preceding embodiment 24, further comprising a processing means (34) for processing the measured values, in particular for determining the spacing between the movable components.

26. Shock absorber system (30) according to the preceding embodiment 24 or 25, further comprising a display means (33) for the display of information, preferably of operating-state information and/or of adjustment information of the shock absorber.

27. Shock absorber system (30) according to the preceding embodiment 24, 25, or 26, further comprising a storage means for the storing of data, such as measurement values, processed measurement values, operating information, adjustment information, and/or display information.

28. Shock absorber system (30) according to any one of the preceding embodiments 24 to 27, wherein the operating unit (31) is configured as a portable computer, in particular as a smartphone.

29. Shock absorber system (30) according to any one of the preceding embodiments 24 to 28, further comprising at least one further sensor (3), in particular a speed-, position-, acceleration-, and/or gyroscopic sensor, wherein the processing means is preferably further configured to take into account measurement values of the further sensor(s) in the display and/or the processing of the measurement values and/or in the determination of display- and/or adjustment-information.

30. Bicycle (1) comprising a shock absorber assembly according to any one of the preceding embodiments 1 to 23 and/or a shock absorber system according to any one of the preceding embodiments 24 to 29, wherein the bicycle is preferably a mountain bike or a racing bike.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved shock absorbers for cycling.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, such as the processing unit or processor, is also understood as a corresponding method step or as a feature of a method step. In an analogous manner, aspects which have been described in the context of or as a method step also represent a description of a corresponding block or detail or feature of a corresponding device, such as the processing unit or processor.

Depending on certain implementation requirements, exemplary embodiments of the processing unit or processor of the present disclosure may be implemented in hardware and/or in software. The implementation can be configured using a digital storage medium (storage means), for example one or more of a ROM, a PROM, an EPROM, an EEPROM or a flash memory, on which electronically readable control signals (program code) are stored, which interact or can interact with a programmable hardware component such that the respective method is performed.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium (storage means) can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the processing unit or processor, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components.

We claim:

1. A shock absorber assembly comprising:
a shock absorber configured to connect first and second subassemblies that are movable relative to each other, and
a distance sensor fixedly disposed in the interior of, or on, the shock absorber or on one of the first and second subassemblies, the distance sensor being configured to determine measurement values representative of a spacing between the first and second subassemblies.

2. The shock absorber assembly according to claim 1, wherein the distance sensor is a time-of-flight sensor comprising a light source in the ultraviolet, visible, or infrared wavelength range.

3. The shock absorber assembly according to claim 2, wherein the first and second subassemblies are displaceable relative to each other along a longitudinal axis.

4. The shock absorber assembly according to claim 3, wherein:
the shock absorber comprises a cylinder configured to be fixedly coupled to one of the first and second subassemblies and a piston configured to be fixedly coupled to the other of the first and second subassemblies; and
the distance sensor is disposed in an interior of the shock absorber.

5. The shock absorber assembly according to claim 4, wherein:
the cylinder and the piston define an air-spring chamber filled with a gas and/or air, and
the distance sensor is disposed in the cylinder.

6. The shock absorber according to claim 5, wherein the air-spring chamber is the exclusive spring element of the shock absorber.

7. The shock absorber assembly according to claim 6, wherein the distance sensor is disposed on the longitudinal axis and/or is oriented to emit light along, or essentially along, the longitudinal axis.

8. The shock absorber assembly according to claim 4, wherein:
the distance sensor is disposed on a base of the cylinder, and
an opposing face of the piston is reflective.

9. The shock absorber assembly according to claim 8, wherein, at a maximum compression of the shock absorber, the distance sensor is spaced 0.1 to 50 mm from the opposing face of the piston.

10. The shock absorber assembly according to claim 3, wherein:
the shock absorber is a front-wheel shock absorber,
the first subassembly comprises a head tube of a bicycle frame and/or a fork steerer tube of a front-wheel fork,
the second subassembly comprises a front wheel and/or a mudguard, and
the distance sensor is fixedly disposed on the first subassembly and emits light toward the second subassembly along or parallel to a fork-steerer-tube axis.

11. The shock absorber assembly according to claim 3, wherein:
the shock absorber is a rear-wheel shock absorber,
the distance sensor is attached to a section of the shock absorber that is fixedly connected to the first subassembly, which section comprises a bottom bracket, and
the distance sensor emits light along, or essentially along, a longitudinal axis of the shock absorber and/or emits light toward the second subassembly.

12. The shock absorber assembly according to claim 1, wherein the distance sensor is configured to periodically determine the measurement values at a sampling rate of 0.01 to 1000 kHz.

13. The shock absorber assembly according to claim 1, further comprising a control unit configured to control and/or read-out the distance sensor.

14. The shock absorber assembly according to claim 1, further comprising a transmission unit and/or a receiving unit configured to communicate data, wirelessly or by wire, between the shock absorber and one or more external operating units at a frequency between 0.01 Hz and 1000 kHz.

15. The shock absorber assembly according to claim 1, further comprising at least one adjusting unit configured to adjust one or more operating parameters of the shock absorber selected from the group consisting of spring stiffness, damping rate during compression and damping rate during rebound.

16. The shock absorber assembly according to claim 1, further comprising:
at least one further sensor selected from the group consisting of a speed sensor, a position sensor, an acceleration sensor and a gyroscopic sensor, and
a processor configured to take into account measurement values of the at least one further sensor while processing the measurement values and/or while generating display information and/or adjustment-information.

17. A shock absorber system comprising:
at least one shock absorber assembly according to claim 1, and
at least one operating unit configured to communicate data with the shock absorber.

18. The shock absorber system according to claim 17, further comprising:
a processor configured to process the measurement values to determine the instantaneous spacing between the movable components;
a display configured to display operating-state information and/or adjustment information of the shock absorber; and
a storage means for storing one or more of the measurement values, processed measurement values, operating information, adjustment information, and display information.

19. The shock absorber system according to claim 18, wherein the operating unit is configured as a portable computer.

20. The shock absorber system according to claim 19, further comprising:
at least one further sensor selected from the group consisting of a speed sensor, a position sensor, an acceleration sensor and a gyroscopic sensor, and
a processor configured to take into account measurement values of the at least one further sensor while processing the measurement values and/or while generating the display information and/or the adjustment-information.
